(19) United States
(12) Patent Application Publication
(10) Pub. No.: US 2026/0115873 A1
(43) Pub. Date: Apr. 30, 2026

(54) POWER TOOL COMPRISING A PULSE UNIT

(71) Applicant: ATLAS COPCO INDUSTRIAL TECHNIQUE AB, Stockholm (SE)

(72) Inventor: Johan RÖNBLOM, Saltsjö-Boo (SE)

(73) Assignee: ATLAS COPCO INDUSTRIAL TECHNIQUE AB, Stockholm (SE)

(21) Appl. No.: 19/478,911

(22) PCT Filed: Apr. 9, 2024
(86) PCT No.: PCT/EP2024/059571

§ 371 Date: Oct. 27, 2025

(30) Foreign Application Priority Data
May 5, 2023 (SE) 2330204-5

(51) Int. Cl. B25B 21/02; B25F 5/00

(52) U.S. Cl. CPC B25B 21/02; B25F 5/001; B25F 5/005

(57) ABSTRACT

The present specification relates to a handheld power tool for delivering torque in pulses comprising an elongated housing, an angle head arranged at a front end of the housing and a driveline comprising a motor arranged in the housing, a bevel gear arranged in the angle head and a pulse unit, wherein the pulse unit is arranged to be driven by the bevel gear. The driveline further comprises a torsional spring assembly arranged to transfer power between a first and a second component of the driveline, such that a limited relative rotation is allowed there between due to the resiliency of the torsional spring assembly.

### CROSS-REFERENCE TO RELATED APPLICATIONS

This application is a national stage application (filed under 35 § U.S.C. 371) of PCT/EP2024/059571, filed Apr. 9, 2024, of the same title, which, in turn claims priority to Swedish Patent Application No. 2330204-5, filed on May 5, 2023; the contents of each of which are hereby incorporated by reference.

### TECHNICAL FIELD

The present invention generally relates to power tools for tightening of threaded fasteners, more particularly to angle type power tools having a hydraulic pulse unit.

### Technical Background

Electrical power tools for tightening are known to be used in various industries. For example, power wrenches of the impulse type comprising hydraulic pulse units are commonly used for continuous heavy production.

In such pulse tools, torque is delivered intermittently, i.e. in pulses, to the output shaft by means of a pulse generating mechanism. Since the pulses are very short, there is almost no reaction force in the handle, only the much lower motor torque is transferred to the operator's hand. In addition, there are less vibrations and noise than with an impact wrench. However, although vibrations during operation are considerably lower compared to for example impact tools, the problem of vibrations still remains.

Typical examples of the use of impact tools are known. JP2004255544, discloses a handheld tool with an angle head arrangement, where vibrations are minimized by means of use of a first washer that is elastically held by an O-ring on an upper side of the spindle together with a second washer that holds a second bevel gear.

Another angle head drill hammer tool is known from JPH03117572U, being a medium-sized drill hammer in which the percussive mechanism and drive motor are perpendicular to one another where a compact, handy structural shape is to be obtained with adequate gear reduction.

One application of particular concern is when pulse units are used on angle tools. Angle tools are tools having an angle head attachment and are primarily used for accessibility reasons. Typically they are built as straight tools provided with an angle head attachment and in some application a pulse unit is attached to the angle head.

More particularly, as the pulse unit stops during each pulse, the motor of such tools which runs at a high speed is also brought to a stop, and particularly sever vibrations arise as these are transmitted back to the operator.

Hence, there exists a need for improvement in the field of angle type power tools comprising hydraulic pulse units.

### SUMMARY OF THE INVENTION

Accordingly, it would be desirable to provide an improved angle type pulse tool. In particular, it would be desirable to provide such a tool where vibration levels are lowered. To better address one or more of these concerns a power tool according to independent claim 1 is provided. Preferred embodiments are defined in the dependent claims.

According to a first aspect of the invention a handheld power tool for delivering torque in pulses is provided. The tool comprises an elongated housing, an angle head arranged at a front end of the housing, and a driveline, the driveline comprising a motor arranged in the housing, a bevel gear arranged in the angle head and a pulse unit, wherein the pulse unit is arranged to be driven by the bevel gear, wherein the driveline further comprises a torsional spring assembly arranged to transfer power between a first and a second component of the driveline, such that a limited relative rotation is allowed there between due to the resiliency of the torsional spring assembly.

According to the first aspect, the power tool (or impulse tool, pulse tool, power wrench or tightening tool, these terms are used interchangeably throughout the present specification) provides an inventive solution to the concerns described above by means of a design incorporating a torsional spring assembly provided in the driveline between two components of the driveline, as seen in the power transferring direction.

More particularly, the design where two components of the driveline may be operatively connected or coupled by a torsion spring assembly, provides for allowing a limited relative movement between the motor and the pulse unit, such that the motor instead of stopping for each pulse can continue running in the driving direction during the pulse (against the bias or resiliency of the spring assembly). Hence, the motor can run at a more or less constant speed when delivering the pulses. Hereby, the torque transmitted back to the operator will be constant, or at least substantially constant, thus greatly reducing the vibrations to which the operator is exposed.

By provided, or arranged, between should be understood that the torsion spring assembly is arranged to operatively connect or couple two components of the driveline, i.e. to be arranged, in the power transfer direction of the driveline, between the two components.

The two components may be any components in the driveline. For example two components arranged, as seen in the power transfer direction of the driveline between the motor and the pulse unit. This may for example be two otherwise, as seen in the power transferring direction of the driveline, (in a conventional driveline) adjacently arranged components. In some embodiments, one of the two components in some embodiments may be the motor and/or the pulse unit, which also form part of the driveline.

The housing may be an elongated substantially cylindrical housing, the angle head may be attached (fixedly or removably) to the front end of the housing and the driveline may be at least partly arranged in and extending through the space formed by (i.e. and hence in) the housing and the angle head. The angle head may be attached to a forward end of the housing and support an output shaft of the bevel gear to which the pulse unit may be operably connected in a laterally extending position. The angle head may further comprise a casing.

The referenced power or pulse tool may be an electrically driven pulse tool or a pneumatically driven pulse tool for tightening of threaded fasteners. According to one embodiment, the power tool is a handheld electrically powered power tool. According to one embodiment, the power tool is a battery powered tool.

According to one embodiment, the driveline further comprises a planetary gear unit. The planetary gear unit may for example be arranged, in the power transferring direction, between and operatively connecting the motor and the bevel gear.

According to one embodiment, the torsional spring assembly is arranged, as seen in the power transfer direction of the driveline, between the planetary gear unit and the bevel gear unit.

According to one embodiment, the torsional spring assembly is arranged, as seen in the power transfer direction of the driveline, between the planetary gear unit and the motor.

According to one embodiment, the torsional spring assembly is arranged between the bevel gear and the pulse unit.

According to one embodiment, the torsional spring assembly comprises a torsion spring element, such as a torsion spring. In some embodiments the torsion spring is a torsion coil spring. The stiffness of the torsion spring element is preferably chosen such that the torsion spring is stiff enough to transfer enough torque from the motor to the pulse unit but soft enough to allow for sufficient relative rotation during the pulse. In one embodiment the number of turns of the torsion coil spring lies in the range 10-40, in one embodiment the number of turns lies in the range 15-35, in one embodiment the number of turns lies in the range 25-30.

In one embodiment, the torsion spring of the torsional spring assembly is a clock spring, possibly a progressive clock spring. In some embodiments, the torsional spring assembly may comprises a torsional resilient screw mechanism. In one embodiment the torsional spring assembly comprises a compression spring acted on by an element comprising cam surfaces arranged to compress the compression spring. In some embodiments, the cam surfaces may further comprise grooves in which balls or rollers arranged to compress the compression spring may be arranged. The compression spring may be a disc spring or a leaf spring.

According to one embodiment, the torsional spring assembly comprises a torsion bar.

According to one embodiment, the torsional spring assembly further comprises a centering shaft assembly around which the torsion coil spring is wound. Hereby, he spring is centered and undesired bending or buckling of the spring is hindered.

According to one embodiment, the shaft assembly comprises a shaft element attached to the first component and a pipe element attached to the second component, wherein the shaft element extends at least partly within the pipe element. The coil spring may be attached to the shaft element at a first end and to the pipe element at the second end.

According to one embodiment, the power tool is adapted to deliver torque pulses in the range 100-300 Nm, such as in the range 150-250 Nm. As vibration levels increase in tools used for tightening to higher torque levels, the invention may be particularly advantageous when implemented in such tools.

According to one embodiment, the pulse unit is a hydraulic pulse unit. According to one embodiment, the hydraulic pulse unit comprises an inertia drive member connected to an outgoing shaft of the bevel gear and rotatable about a rotation axis, an oil chamber enclosed in the inertia drive member and impulse generating means arranged to intermittently transfer kinetic energy to an impulse receiving portion of an output shaft received within the oil chamber.

According to one embodiment, the power tool is tranducerized tool, i.e. the tool comprises one or more sensors for retrieving data relating to the operation of the tool. According to one embodiment, the power tool comprises a torque transducer or sensor and/or a current sensor. For example, a sensor may be arranged to measure the angular velocity of the pulse unit and the installed torque may be retrieved from a derivative of the velocity. The invention may be particularly advantageous when implemented in a transducerized tool, since the friction which may affect the measurement is not only lowered, but also more even.

Further objectives of, features of and advantages of the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The invention will be described in the following illustrative and non-limiting detailed description of exemplary embodiments, with reference to the appended drawing, on which

FIG. 1a is a perspective view of an exemplary power tool.

FIG. 1b is a cross sectional side view of an exemplary power tool.

FIG. 2a is a perspective view of an exemplary power tool.

FIG. 2b is a cross sectional side view of an exemplary power tool.

All figures are schematic, not necessarily to scale and generally only show parts which are necessary in order to elucidate the invention, wherein other parts may be omitted or merely suggested.

### DETAILED DESCRIPTION

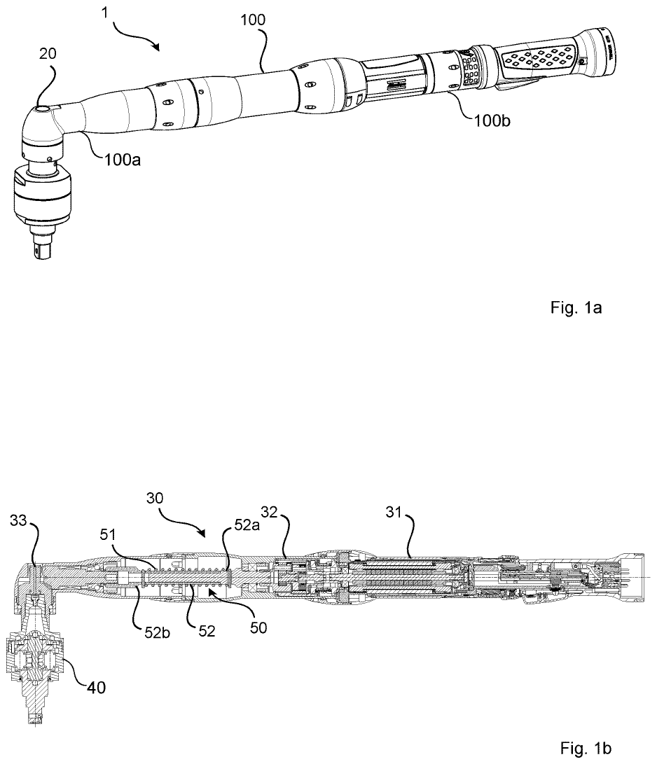

FIG. 1a shows an exemplary pulse tool 1 according to one embodiment, in this case an electrically powered handheld angle type tool 1 comprising an elongated cylindrical housing 100 having a front end 100a. An angle head 20 is arranged at the front end of the housing 100a.

As may be seen from FIG. 1b, a drive line 30 is partly arranged in, and hence extending through, the space formed by the housing 100 and angle head 20. The driveline comprising a motor 31 arranged at the rear portion 100b of the housing, a planetary gear unit 32 operatively connected to the motor 31, a bevel gear 33 arranged in the angle head 20 and a pulse unit 40 operatively connected and arranged to be driven by a laterally extending output end of the bevel gear 33. The pulse unit 40 extending at the angle head output forming part of the drive line 30, is a hydraulic pulse unit 40 comprising an inertia drive member connected to an outgoing shaft of the bevel gear 33 and rotatable about a rotation axis, an oil chamber enclosed in the inertia drive member and impulse generating means arranged to intermittently transfer kinetic energy to an impulse receiving portion of an output shaft received within the oil chamber. The operation of such impulse mechanism per se is known in the art and will not be described in any further detail, similar mechanisms has been previously described for example in U.S. Pat. Nos. 6,110,045 and 13,697,107.

The driveline in the illustrated embodiment further comprises a torsional spring assembly 50 arranged, when viewed in the driving direction of the driveline, between, and operatively connected, to the planetary gear unit 32 and the bevel gear unit 33.

The torsional spring assembly 50 comprises a centering shaft assembly 52 around which a torsion coil spring 51 is wound. The shaft assembly 52 comprises a shaft element 52a which in the illustrated embodiment is attached to the planetary gear unit 32 and a pipe element 52b is in the illustrated embodiment attached to the bevel gear 33. The coil spring 51 is attached to the shaft element at a first end and to the pipe element 52b at the second end and extends over most of the length of the shaft assembly. The shaft element 52a extends inside the pipe element 52b and these two overlapping elements may hence rotate with respect to one another against the bias of the torsion spring 51. In the illustrated embodiment, the shaft assembly 52 is attached to the planetary gear unit 32 and the bevel gear 33 by means of splines.

Hereby, the torsional spring assembly 50 is arranged to transfer power between, in this case, the planetary gear unit 32 and the bevel gear 33 unit in a manner allowing a limited relative rotation between the two due to the resiliency of the torsional spring assembly 50. This in turn allows for the motor 31, which is operatively connected to the planetary gear unit 32, to rotate a limited distance with respect to the pulse unit 40, which is operatively connected to the bevel gear 33, and thus allows for the motor 31 to continue in forward rotation also during pulsing when the pulse unit 40 intermittently stops.

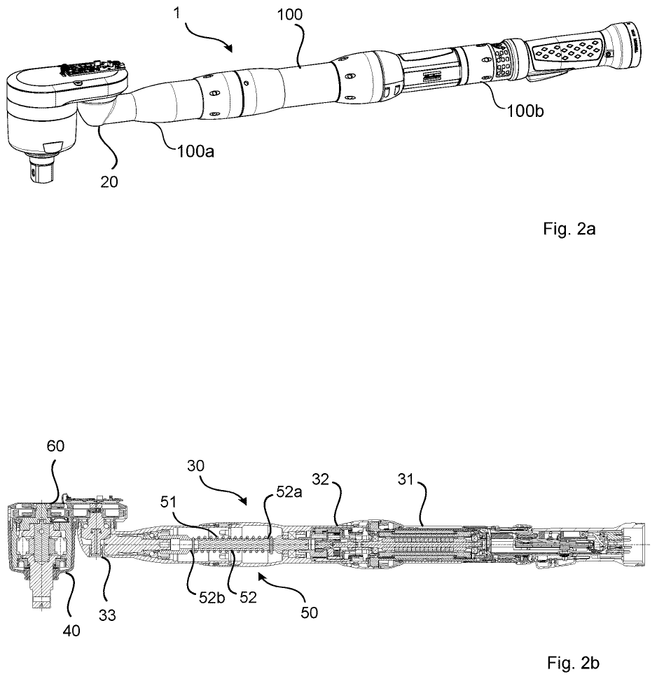

FIG. 2a shows an exemplary pulse tool 1 according to another embodiment, as for the embodiment in FIGS. 1a and b, an electrically powered handheld angle type tool 1 comprising an elongated cylindrical housing 100 having a front end 100a. An angle head 20 is arranged at the front end of the housing 100a.

As may be seen from FIG. 2b, a drive line 30 is partly arranged in and hence extends through the space formed by the housing 100 and angle head 20. The driveline comprising a motor 31 arranged at a rear portion 100b of the housing, a planetary gear unit 32 operatively connected to the motor 31, a bevel gear 33 arranged in the angle head 20 and a pulse unit 40 operatively connected and arranged to be driven by a laterally extending output end of the bevel gear 33. The pulse unit 40 is a hydraulic pulse unit as described with reference to FIG. 1 above.

The driveline in the illustrated embodiment further comprises an offset gear assembly 60 arranged, when viewed in the driving direction of the driveline, between and operatively connected to the bevel gear unit 33 and the pulse unit 40. As may be seen from FIGS. 2a and 2b, the orientation of the pulse unit 40 has been inverted as compare to the embodiment of FIG. 1, this provides an advantageously compact design.

Similarly to the embodiment in FIGS. 1a and b, the driveline 30 in the illustrated embodiment further comprises a torsional spring assembly 50 arranged, when viewed in driving direction of the driveline, between and operatively connected to the planetary gear unit 32 and the bevel gear unit 33.

The design and function of the torsional spring assembly 50 shown in FIG. 2b is basically the same as for the embodiment show in FIG. 1b.

While the invention has been illustrated and described in detail in the drawings and foregoing description, such illustration and description are to be considered illustrative or exemplary and not restrictive; the invention is not limited to the disclosed embodiment. The skilled person understands that many modifications, variations and alterations are conceivable within the scope as defined in the appended claims. Additionally, variations to the disclosed embodiments can be understood and effected by those skilled in the art in practicing the claimed invention, form a study of the drawings, the disclosure and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

1-14. (canceled)

15. A handheld power tool for delivering torque in pulses, said handheld power tool comprising:
an elongated housing;
an angle head arranged at a front end of said housing; and
a driveline, said driveline comprising:
a motor arranged in said housing,
a planetary gear unit;
a bevel gear arranged in said angle head;
a pulse unit, wherein said pulse unit is arranged to be driven by said bevel gear,
a torsional spring assembly arranged to transfer power between a first and a second component of said driveline, such that a limited relative rotation is allowed there between due to the resiliency of the torsional spring assembly, said torsional spring assembly arranged, between either said planetary gear unit and said bevel gear unit, or between the planetary gear unit and said motor.

16. A handheld power tool according to claim 15, wherein said torsional spring assembly comprises a torsion coil spring.

17. A handheld power tool according to claim 16, wherein said torsional spring assembly further comprises a centering shaft assembly around which the torsion coil spring is wound.

18. A handheld power tool according to claim 17, wherein said centering shaft assembly comprises a shaft element attached to said first component and a pipe element attached to said second component, and wherein said shaft element extends at least partly within said pipe element.

19. A handheld power tool according to claim 15, wherein said torsional spring assembly comprises a torsion bar.

20. A handheld power tool according to claim 15, wherein said power tool is an electrically-powered power tool.

21. A handheld power tool according to claim 15, wherein said power tool is a battery-powered power tool.

22. A handheld power tool according to claim 15, wherein said power tool is adapted to deliver torque pulses in the range of 100-300 Nm.

23. A handheld power tool according to claim 15, wherein said power tool is adapted to deliver torque pulses in the range of 150-250 Nm.

24. A handheld power tool according to claim 15, wherein the pulse unit is a hydraulic pulse unit.

25. A handheld power tool according to claim 24, wherein said hydraulic pulse unit comprises:
an inertia drive member connected to an outgoing shaft of the bevel gear and rotatable about a rotation axis;
an oil chamber enclosed in the inertia drive member; and
impulse generating means arranged to intermittently transfer kinetic energy to an impulse receiving portion of an output shaft received within the oil chamber.
